(19) United States
(12) Patent Application Publication
(10) Pub. No.: US 2010/0045364 A1
(43) Pub. Date: Feb. 25, 2010

(54) ADAPTIVE VOLTAGE BIAS METHODOLOGY

(75) Inventors: Oscar M. K. Law, Markham (CA); Kong-Beng Thei, Hsin-Chu Country (TW); Harry Chuang, Hsin-Chu City (TW)

Correspondence Address: HAYNES AND BOONE, LLP;IP Section, 2323 Victory Avenue, Suite 700, Dallas, TX, 75219, US

(73) Assignee: TAIWAN SEMICONDUCTOR MANUFACTURING COMPANY, LTD., Hsin-Chu (TW)

(21) Appl. No.: 12/496,852

(22) Filed: Jul. 2, 2009

Related U.S. Application Data
(60) Provisional application No. 61/091,603, filed on Aug. 25, 2008.

(51) Int. Cl. G05F 3/02

(52) U.S. Cl. 327/534

(57) ABSTRACT

The present disclosure provides an integrated circuit. The integrated circuit includes a frequency detector coupled with a logic circuit; a supply voltage regulator coupled with the frequency detector and designed to provide an adaptive voltage supply to the logic circuit based on a frequency error from the frequency detector; and a substrate bias regulator coupled with the frequency detector and designed to provide an adaptive body bias voltage to the logic circuit based on the frequency error.

### PRIORITY DATA

This application claims priority to Provisional Application Ser. No. 61/091,603, filed on Aug. 25, 2008, entitled “ADAPTIVE VOLTAGE BIAS METHODOLOGY,” the entire disclosure of which is incorporated herein by reference.

### BACKGROUND

Power dissipation is a concern and challenge in integrated circuit (IC) designs and applications. Various approaches have been used to reduce the power dissipation. For example, dual power is used in integrated circuits to reduce the power dissipation. In existing technologies, a power reduction technique reduces either an active power (Multiple Voltage Supply) or leakage power (Mixed Vt). Moreover, due to smaller geometries with advanced processes, the circuit performance is more sensitive to the process variations. Although these approaches have been satisfactory for their intended purposes, they have not been satisfactory in all respects. For example, the existing approaches may not effectively minimize the power dissipation due to the process variations. Two or more power reduction techniques are required for overall power reduction. It complicates the design and increases the production cost significantly. Moreover, there is no unified approach to reduce the power dissipation as well as account for the process variations at the same time.

### SUMMARY

One of the broader forms of an embodiment of the present invention involves an integrated circuit. The integrated circuit includes a frequency detector coupled with a logic circuit; a supply voltage regulator coupled with the frequency detector and designed to provide an adaptive voltage supply to the logic circuit based on a frequency error from the frequency detector; and a substrate bias regulator coupled with the frequency detector and designed to provide an adaptive body bias voltage to the logic circuit based on the frequency error.

Another one of the broader forms of an embodiment of the present invention involves an adaptive voltage bias control system. The system includes a frequency detector coupled with a logic circuit; an adaptive controller coupled with the frequency detector; a first voltage regulator coupled with the frequency detector and designed to provide a dynamic voltage supply to the logic circuit; and a second voltage regulator coupled with the frequency detector and designed to provide a dynamic voltage bias to a substrate region of the logic circuit.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Various drawings and associated text are provided in a Power Point file. Particularly,

FIGS. 1 through 7 are schematic views of various integrated circuits for adaptive voltage bias constructed according to various aspects of the present disclosure in different more embodiments.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

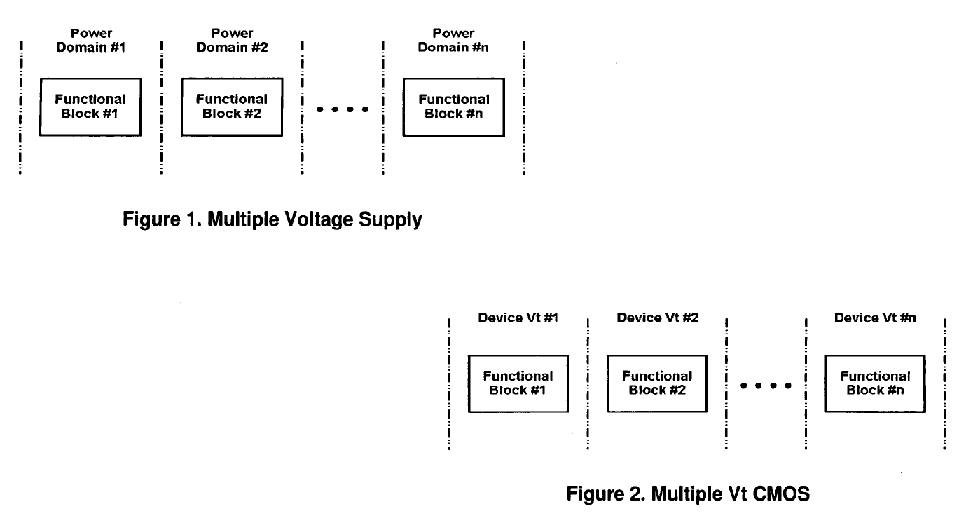

FIGS. 1 through 7 are schematic views of various integrated circuits for adaptive voltage bias constructed according to various aspects of the present disclosure in different embodiments. An adaptive voltage bias control system and a method for operating a logic circuit in an adaptive voltage bias are collectively described with reference to FIGS. 1 through 7.

FIG. 1 illustrates a method to operate an integrated circuit. In a multiple voltage supply (MVS) methodology, the design divides the integrated circuit into multiple power domains based on their functionality as illustrated in FIG. 1. For example, the integrated circuit is divided into multiple functional blocks, such as a functional block 1, a functional block 2, . . . and a functional block n. The voltage supply is adjusted separately through a power gating circuitry to reduce the overall power dissipation.

FIG. 2 illustrates another method to operate an integrated circuit. In this method, the design divides the integrated circuit into multiple threshold domains based on the device structure as illustrated in FIG. 2. For example, the integrated circuit is divided into multiple functional blocks, such as a functional block 1, a functional block 2, . . . and a functional block n. Each functional block includes devices with similar threshold voltage. The voltage supply is separately provided to each functional block with a voltage level according to its threshold voltage (Vt). This mixed Vt approach employs various Vt devices to reduce overall leakage power. In one example, standard Vt devices are used in critical path to achieve performance target and high Vt devices are used in non-critical path to limit the leakage current.

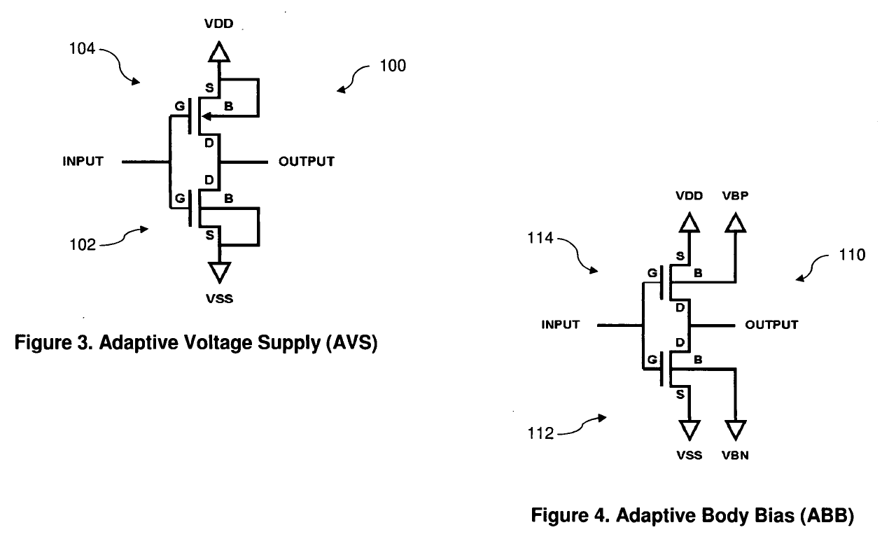

FIG. 3 illustrates a method of an adaptive voltage supply (AVS) to operate an integrated circuit constructed according to aspects of the present disclosure. In one embodiment, the integrated circuit includes a logic circuit having various field effect transistors (FETs). In one example, the FETs are metal-oxide-semiconductor FETs (MOSFETs). In another embodiment, the logic circuit includes an inverter 100 as illustrated in FIG. 3. The inverter includes a n-type FET (nFET) 102 and a p-type FET (pFET) 104. The nFET and pFET are configured such that the gate of the nFET and the gate of the pFET are connected to an input, and the drain of the nFET and the drain of the pFET are connected to an output. Furthermore, the source of the nFET is connected to a lower power line Vss. The source of the pFET is connected an higher power source Vdd. The body (substrate) of the nFET is biased to Vss and the body of the pFET is biased to Vdd. Particularly, the voltage Vdd is dynamic instead of a fixed value. In this method and configuration, the adaptive voltage supply adjusts the voltage supply (Vdd) dynamically based on the operating conditions for active power reduction. In another embodiment, the voltage to the Vss is dynamic instead of a fixed value. In this case, the adaptive voltage supply adjusts the voltage supply (Vss) dynamically based on the operating conditions.

FIG. 4 illustrates a method of an adaptive body bias (ABB) to operate an integrated circuit constructed according to aspects of the present disclosure. In one embodiment, the integrated circuit includes a logic circuit having various field effect transistors (FETs). In another embodiment, the logic circuit includes an inverter 110 as illustrated in FIG. 4. The inverter 110 includes a nFET 112 and a pFET 114. The nFET and pFET are configured such that the gate of the nFET and the gate of the pFET are connected to an input, and the drain of the nFET and the drain of the pFET are connected to an output. Furthermore, the source of the nFET is connected to a lower power line Vss. The source of the pFET is connected an higher power source Vdd. The body (substrate) of the nFET is biased to Vbn and the body of the pFET is biased to Vbp. Particularly, the voltage Vbp is dynamic and the voltage Vbn is dynamic. The ABB adjusts the body bias (Vbp/Vbn) dynamically based on the operating conditions. The ABB approach modifies both pFET and nFET for substrate bias (VBP/VBN) adaptively for process variation compensation to achieve performance target.

In one embodiment, AVS and/or ABB are employed through unified techniques. In another embodiment of implementing AVS and/or ABB, dynamic voltage supply and dynamic pFET body bias provide advantages such as reduced power dissipation and reduced impact of the process variation. In various examples, the process variation or its result includes gate length variation, doping concentration variation or gate dielectric thickness variation. In various situations, one or more advantages may present. These advantages include reducing both active and leakage power without performance degradation; reducing process variation for performance yield improvement without additional process step; easily integrating the technique with current design flow without complex layout modification; and simplifying the control through voltage supply and PMOS substrate bias adjustment only.

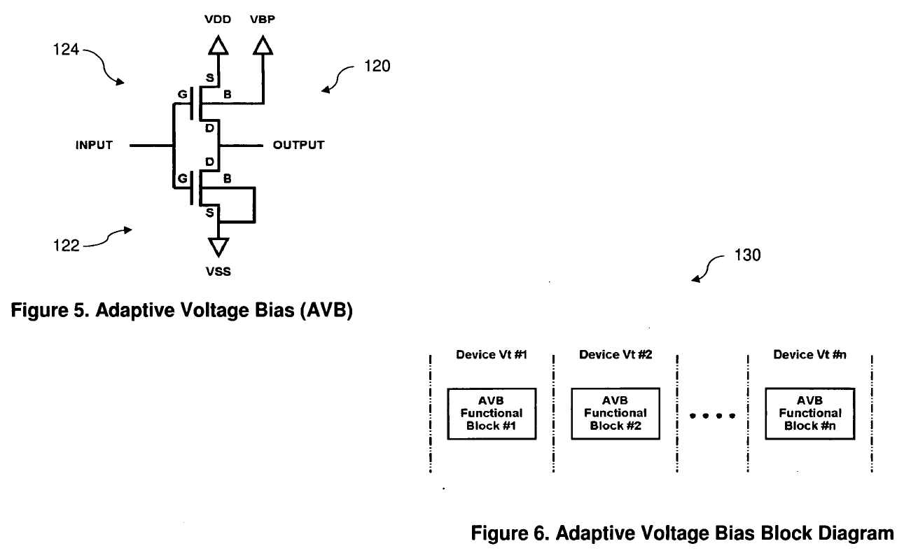

FIG. 5 illustrates a method of an adaptive voltage bias (AVB) to operate an integrated circuit constructed according to aspects of the present disclosure. In one embodiment, the integrated circuit includes a logic circuit having various field effect transistors (FETs). In another embodiment, the logic circuit includes an inverter 120 as illustrated in FIG. 5. The inverter includes a n-type FET (nFET) 122 and a p-type FET (pFET) 124. The nFET and pFET are configured such that the gate of the nFET and the gate of the pFET are connected to an input, and the drain of the nFET and the drain of the pFET are connected to an output. Furthermore, the source of the nFET is connected to a lower power line Vss. The source of the pFET is connected to an higher power line Vdd. The body of the nFET is biased to Vss and the body of the pFET is biased to Vbp. Particularly, the voltage Vdd is dynamic instead of a fixed value. Similarly, the voltage Vbp is dynamic instead of a fixed value. The AVB employs both AVS and ABB methodologies to adjust voltage supply and pFET body bias (Vbp) dynamically to achieve overall power reduction and minimize process variation. Since only pFET body bias (VBP) is modified, no additional process step (i.e. triple N-well) is required to isolate NMOS substrate.

FIG. 6 illustrates a method of an adaptive voltage bias (AVB) to operate an integrated circuit 130 constructed according to aspects of the present disclosure according to another embodiment. The integrated circuit 130 includes various functional blocks such as functional blocks 1, 2, . . . and n. Each functional block includes devices of an individual threshold voltage to the associated functional block, such as device Vt #1, device Vt #2, . . . and device Vt #n. Each functional block is operated with the AVB method. In this case, AVB approach employs various Vt devices similar to the mixed Vt approach. The AVB approach employs low Vt devices in critical path and employs standard Vt devices in non-critical path to achieve the performance target with low supply voltage for both active and leakage power reduction.

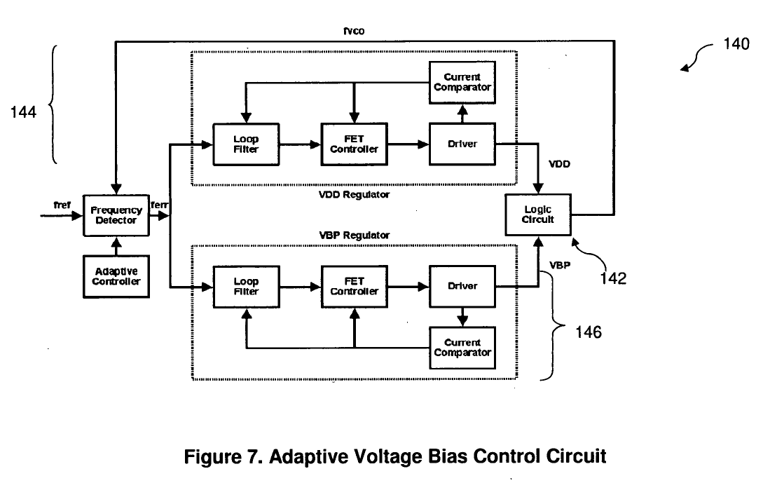

FIG. 7 illustrates an adaptive voltage bias control system 140 to operate an integrated circuit 142 constructed according to aspects of the present disclosure according to one or more embodiments. In one embodiment, the integrated circuit 142 includes a logic circuit having various field effect transistors (FETs). In another embodiment, the logic circuit includes one or more inverters similar to the inverter 120 as illustrated in FIG. 5. In another embodiment, the FETs includes one or more metal-oxide-semiconductor FETs (MOSFETs) such as nMOS and pMOS transistors. In another embodiment, the MOSFETs utilize metal for gate electrode and high k material for gate dielectric.

The adaptive voltage bias control system 140 includes multiple functional modules. The adaptive voltage bias control system 140 includes a frequency detector connected to the integrated circuit 142. The frequency detector is designed to compare between the operation frequency fvco of the integrated circuit and a reference frequency fref. In one example, the operation frequency fvco is generated from an internal sampling circuit, such as a ring oscillator or a data path, of the integrate circuit. As one embodiment, ferr=fref−fvco. In one example, the operating state is slow if ferr<0, fast if ferr>0, or normal if ferr=0.

The adaptive voltage bias control system 140 includes an adaptive controller. In one embodiment, the adaptive controller is used to adjust the reference frequency fref according to operating conditions. For example, the fref is generated from a source with a fixed frequency. The adaptive controller then adjusts the fref according to the operating conditions. In another example, the operating condition is determined by the system operated in different modes (fast, slow and normal), depending on applications. In one example for illustration, if the fref is 10 MHz, the adaptive controller adjusts the fref to 1 MHz (slow), 5 MHz (normal) or 10 MHz (fast) before the fvco comparison. Another operating condition is standby. The frequency detector then generates the frequency error ferr after the fref is adjusted by the adaptive controller.

The adaptive voltage bias control system 140 includes an voltage supply regulator 144 and a substrate bias regulator 146. In shown in FIG. 7, the voltage supply regulator 144 is also labeled as “Vdd regulator” and the substrate bias regulator 146 is labeled as “Vbp regulator”. The frequency detector generates the frequency error ferr and then provides the ferr to the voltage supply regulator 144 and the substrate bias regulator 146.

In one embodiment, each of the voltage supply regulator 144 and the substrate bias regulator 146 includes a loop filter, a FET controller, a driver and a current comparator. The loop filter is used to convert ferr into an equivalent voltage error based on a lookup table approach. It translates the voltage error to a control command for FET controller. The FET controller controls a driver, such as a power FET, to provide a voltage (supply voltage or substrate bias voltage) to the logic circuits. The current comparator is used to cancel the voltage offset of the associated regulator. Thus, the adaptive voltage bias control system adjusts the power supply Vdd and the body bias voltage Vbp dynamically to reduce both active power and leakage power. The process variation is also compensated and its impact to the circuit is reduced for performance improvement.

Table 1 is also provided for illustration. The table 1 shows basic AVB operation of the AVB method according to one or more embodiments. In this table, Vdd represents voltage supply and Vbp represents pFET substrate bias. The “−”, “+” and “NOP” represent various adaptive controls to the logic circuit. Particularly, “−” stands for backward bias, “+” for forward bias and “NOP” for no operation. Various elements X/X in the table is defined as PMOS/NMOS bias conditions. It is further divided into weak forward bias “f”, strong forward bias “F”, weak backward bias “b”, strong backward bias “B” and no operation “N”. Table 2 is also provided for illustration. Based on various Vdd/Vbp configurations, the logic circuit is operated at different bias mode to minimize the process variation. The table 2 shows various operation modes, such as fast, slow and normal, of the AVB method according to one or more embodiments. In another embodiment, the voltage supply can be adjusted based on operational modes (i.e. fast, normal, slow) with similar Vdd/Vbp configuration to further reduce the power dissipation as illustrated in Table 2. During a standby mode, Vdd and/or Vbp is further reduced to minimize the standby current.

TABLE 1
Adaptive Voltage Bias Operation

VBP

| | | − | NOP | + |
|---|---|---|---|---|
| VDD | − | N/b | b/b | B/B |
| | NOP | f/N | N/N | b/N |
| | + | F/F | f/f | N/f |

TABLE 2
Operation Modes Operation

PMOS

| | | Fast | Normal | Slow |
|---|---|---|---|---|
| NMOS | Fast | B/B | b/b | N/b |
| | Normal | b/N | N/N | f/N |
| | Slow | N/f | f/f | F/F |

In Table 1, it shows basic AVB operation where VDD is voltage supply and VBP is PMOS substrate bias. X/X is defined as PMOS/NMOS bias conditions.
It further divided into weak (i.e. f)/strong (i.e. F) forward bias and weak (i.e. b) and strong (i.e. B) backward bias.
Based on various VDD/VBP configuration, the logic circuit is operated at different bias mode to minimize the process variation.
Moreover, the voltage supply can be adjusted based on operational modes (i.e. fast, normal, slow) with similar VDD/VBP configuration to further reduce the power dissipation shown in Table 2.
During standby mode, VDD/VBP is further reduced to minimize the standby current

The adaptive voltage bias control circuit 140 and various adaptive voltage bias methods serve only as different examples within which various aspects of the disclosed adaptive voltage approach may be implemented. For example, the AVB approach may provide various combinations of dynamical voltages to pFET power supply, pFET body bias and nFET power supply. For another example, the integrated circuit, to which the adaptive voltage bias method is applicable and the adaptive voltage bias control circuit is connected, may include one or more field effect transistors (FETs). The FETs may include various MOS transistors. In another example, the MOS transistors utilize high k material for gate dielectric and metal for gate electrode. The integrated circuit may include one or more inverters. The integrated circuit may include a strained semiconductor structure, a hetero-semiconductor device or a stress-free isolation structure.

The present disclosure may be used in various applications. For example, the integrated circuit includes an LCD driver circuit, an image sensor circuit, a dynamic random access memory (DRAM) cell, a single electron transistor (SET), and/or other microelectronic devices (collectively referred to herein as microelectronic devices). In another embodiment, the integrated circuit includes FinFET transistors. Of course, aspects of the present disclosure are also applicable and/or readily adaptable to other type of transistor, such as multiple-gate transistors, and may be employed in many different applications, including sensor cells, memory cells, logic cells, and others.

Thus, the present disclosure provides an integrated circuit that includes a frequency detector coupled with a logic circuit; a supply voltage regulator coupled with the frequency detector and designed to provide an adaptive voltage supply to the logic circuit based on a frequency error from the frequency detector; and a substrate bias regulator coupled with the frequency detector and designed to provide an adaptive body bias voltage to the logic circuit based on the frequency error.

According to one or more embodiments of the disclosed integrated circuit, the frequency detector is designed to collect an operation frequency from the logic circuit; and generate the frequency error based on a difference between the operation frequency and a reference frequency. The disclosed integrated circuit further includes an adaptive controller coupled with the frequency detector and designed to adjust the reference frequency based on an operating condition. The operating condition is associated with a mode selected from the group consisting of a fast mode, a slow mode and a normal mode. The supply voltage regulator is designed to provide the adaptive voltage supply dynamically to the logic circuit. The substrate bias regulator is designed to provide the adaptive body bias voltage dynamically to the logic circuit. The logic circuit may include a metal-oxide-semiconductor field effect transistor (MOSFET). The logic circuit may further include an inverter having an n-type MOSFET (nMOSFET) and a p-type MOSFET (pMOSFET). The supply voltage regulator is designed to provide the adaptive supply voltage to a source region of the pMOSFET. The substrate bias regulator is designed to provide the adaptive body bias voltage to a substrate region of the pMOSFET. Each of the supply voltage regulator and the substrate bias regulator may further include a loop filter coupled to the frequency detector and designed to convert the frequency error into an equivalent voltage error; a field effect transistor (FET) controller coupled to the loop filter; and a driver coupled with the FET controller and designed to provide a voltage to the logic circuit. Each of the supply voltage regulator and the substrate bias regulator may Additionally include a current comparator coupled with the associated driver and designed to cancel a voltage offset of the associated regulator. The disclosed integrated circuit may include more than one module designed to control a second logic circuit. Similarly, a second module may include a second frequency detector; coupled with the second logic circuit; a second supply voltage regulator coupled with the second frequency detector and designed to provide a second adaptive voltage supply to the second logic circuit based on a second frequency error from the second frequency detector; and a second substrate bias regulator coupled with the second frequency detector and designed to provide a second adaptive body bias voltage to the second logic circuit based on the second frequency error.

The present disclosure also provides another embodiment of an adaptive voltage bias control system. The system includes a frequency detector coupled with a logic circuit; an adaptive controller coupled with the frequency detector; a first voltage regulator coupled with the frequency detector and designed to provide a dynamic voltage supply to the logic circuit; and a second voltage regulator coupled with the frequency detector and designed to provide a dynamic voltage bias to a substrate region of the logic circuit.

Various embodiments of the disclosed system are further provided. The frequency detector is designed to provide a frequency error to the first and second voltage regulator based on an operation frequency of the logic circuit and a reference frequency. The adaptive controller is designed to further adjust the reference frequency based an operating condition. The operating condition includes one elected from the group consisting of a fast condition, a slow condition and a normal condition. The first voltage regulator is designed to provide the dynamic voltage supply to the logic circuit based on the frequency error. The second voltage regulator is designed to provide the dynamic voltage basis to the substrate of the logic circuit based on the frequency error. The disclosed adaptive voltage bias control system is designed operable to reduce active power, leakage power and process variation for performance improvement.

The present disclosure also provides one embodiment of a method for operating an integrated circuit. The method includes applying a first dynamic voltage to a field effect transistor (FET) for power supply; and applying a second dynamic voltage to the FET for body bias.

In various embodiments, the method may further include generating a frequency error based on an operation frequency of the FET and a reference frequency; generating the first dynamic voltage by a first voltage regulator based on the frequency error; and generating the second dynamic voltage by a second voltage regulator based on the frequency error. The method may further include adjusting the reference frequency, before the generating of the frequency error, based on an operating condition. The operation condition may be one selected from the group consisting of a fast mode, a slow mode, a normal mode and a standby mode. The applying one the first and second dynamic voltages may include applying said one of the first and second dynamic voltages to the FET in a dynamic way in order to reduce at least one active power, leakage power and process variation for performance improvement.

The foregoing has outlined features of several embodiments. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An integrated circuit comprising:
a frequency detector coupled with a logic circuit;
a supply voltage regulator coupled with the frequency detector and designed to provide an adaptive voltage supply to the logic circuit based on a frequency error from the frequency detector; and
a substrate bias regulator coupled with the frequency detector and designed to provide an adaptive body bias voltage to the logic circuit based on the frequency error.

2. The integrated circuit of claim 1, wherein the frequency detector is designed to:
collect an operation frequency from the logic circuit; and
generate the frequency error based on a difference between the operation frequency and a reference frequency.

3. The integrated circuit of claim 2, further comprising an adaptive controller coupled with the frequency detector and designed to adjust the reference frequency based on an operating condition.

4. The integrated circuit of claim 3, wherein the operating condition is associated with a mode selected from the group consisting of a fast mode, a slow mode and a normal mode.

5. The integrated circuit of claim 1, wherein the supply voltage regulator is designed to provide the adaptive voltage supply dynamically to the logic circuit.

6. The integrated circuit of claim 1, wherein the substrate bias regulator is designed to provide the adaptive body bias voltage dynamically to the logic circuit.

7. The integrated circuit of claim 1, wherein the logic circuit comprises a metal-oxide-semiconductor field effect transistor (MOSFET).

8. The integrated circuit of claim 1, wherein the logic circuit further comprising an inverter having an n-type MOSFET (nMOSFET) and a p-type MOSFET (pMOSFET).

9. The integrated circuit of claim 8, wherein the supply voltage regulator is designed to provide the adaptive supply voltage to a source region of the pMOSFET.

10. The integrated circuit of claim 8, wherein the substrate bias regulator is designed to provide the adaptive body bias voltage to a substrate region of the pMOSFET.

11. The integrated circuit of claim 1, wherein each of the supply voltage regulator and the substrate bias regulator comprises:
a loop filter coupled to the frequency detector and designed to convert the frequency error into an equivalent voltage error;
a field effect transistor (FET) controller coupled to the loop filter; and
a driver coupled with the FET controller and designed to provide a voltage to the logic circuit.

12. The integrated circuit of claim 11, wherein each of the supply voltage regulator and the substrate bias regulator further comprises a current comparator coupled with the associated driver and designed to cancel a voltage offset of the associated regulator.

13. The integrated circuit of claim 1, further comprising
a second frequency detector coupled with a second logic circuit;
a second supply voltage regulator coupled with the second frequency detector and designed to provide a second adaptive voltage supply to the second logic circuit based on a second frequency error from the second frequency detector; and
a second substrate bias regulator coupled with the second frequency detector and designed to provide a second adaptive body bias voltage to the second logic circuit based on the second frequency error.

14. An adaptive voltage bias control system comprising:
a frequency detector coupled with a logic circuit;
an adaptive controller coupled with the frequency detector;
a first voltage regulator coupled with the frequency detector and designed to provide a dynamic voltage supply to the logic circuit; and
a second voltage regulator coupled with the frequency detector and designed to provide a dynamic voltage bias to a substrate region of the logic circuit.

15. The system of claim 14, wherein the frequency detector is designed to provide a frequency error to the first and second voltage regulator based on an operation frequency of the logic circuit and a reference frequency.

16. The system of claim 15, wherein the adaptive controller is designed to further adjust the reference frequency based an operating condition.

17. The system of claim 16, wherein the operating condition includes one elected from the group consisting of a fast condition, a slow condition and a normal condition.

18. The system of claim 15, wherein the first voltage regulator is designed to provide the dynamic voltage supply to the logic circuit based on the frequency error.

19. The system of claim 15, wherein the second voltage regulator is designed to provide the dynamic voltage basis to the substrate of the logic circuit based on the frequency error.

20. The system of claim 1, being designed operable to reduce active power, leakage power and process variation for performance improvement.
